(19) United States
(12) Patent Application Publication
(10) Pub. No.: US 2016/0303507 A1
(43) Pub. Date: Oct. 20, 2016

(54) GAS SEPARATION MEMBRANE MODULE WITH INTEGRATED FILTER

(71) Applicant: Generon IGS, Inc., Houston, TX (US)

(72) Inventors: John A. Jensvold, Benicia, CA (US); Marc Straub, Brentwood, CA (US); Kyle A. Jensvold, Walnut Creek, CA (US); Jeff C. Schletz, Clayton, CA (US)

(21) Appl. No.: 14/850,179

(22) Filed: Sep. 10, 2015

Related U.S. Application Data
(60) Provisional application No. 62/148,796, filed on Apr. 17, 2015.

(51) Int. Cl. B01D 53/22; B01D 63/02; B01D 53/04

(52) U.S. Cl. CPC B01D 53/229; B01D 53/227; B01D 53/0407; B01D 63/02; B01D 2053/224; B01D 2253/102; B01D 2313/90

(57) ABSTRACT

A gas separation membrane module includes hollow polymeric fibers held within a casing, the fibers being anchored by tubesheets at the ends of the casing. A filter material, preferably made of an activated carbon fiber fabric, is integral with the module, such that all gas entering the module must pass first through the filter before reaching the fibers. The filter may have the form of a circular pad affixed to one of the tubesheets. Alternatively, the filter could be a wrap disposed around the fibers, inside the casing. In another alternative, the filter could be provided within a core tube, in cases where a feed gas is introduced through the core of the module. In another embodiment, the filter could be provided in a separate unit from the gas separation module.

### CROSS-REFERENCE TO RELATED APPLICATION

Priority is claimed from U.S. provisional patent application Ser. No. 62/148,796, filed Apr. 17, 2015, the entire disclosure of which is hereby incorporated by reference.

### BACKGROUND OF THE INVENTION

The present invention relates to the non-cryogenic separation of gas mixtures. The invention provides an improved module containing polymeric fiber membranes for gas separation, wherein the module includes or is accompanied by an improved filter.

It has been known to use a polymeric membrane to separate air into components. Various polymers have the property that they allow different gases to flow through, or permeate, the membrane, at different rates. A polymer used in air separation, for example, will pass oxygen and nitrogen at different rates. The gas that preferentially flows through the membrane wall is called the “permeate” gas, and the gas that tends not to flow through the membrane is called the “non-permeate” or “retentate” gas. The selectivity of the membrane is a measure of the degree to which the membrane allows one component, but not the other, to pass through.

A membrane-based gas separation system has the inherent advantage that the system does not require the transportation, storage, and handling of cryogenic liquids. Also, a membrane system requires relatively little energy. The membrane itself has no moving parts; the only moving part in the overall membrane system is usually the compressor which provides the gas to be fed to the membrane.

A gas separation membrane unit is typically provided in the form of a module containing a large number of small, hollow fibers made of the selected polymeric membrane material. The module is generally cylindrical, and terminates in a pair of tubesheets which anchor the hollow fibers. The tubesheets are impervious to gas. The fibers are mounted so as to extend through the tubesheets, so that gas flowing through the interior of the fibers (known in the art as the bore side) can effectively bypass the tubesheets. But gas flowing in the region external to the fibers (known as the shell side) cannot pass through the tubesheets.

In operation, a gas is introduced into a membrane module, the gas being directed to flow through the bore side of the fibers. One component of the gas permeates through the fiber walls, and emerges on the shell side of the fibers, while the other, non-permeate, component tends to flow straight through the bores of the fibers. The non-permeate component comprises a product stream that emerges from the bore sides of the fibers at the outlet end of the module.

Alternatively, the gas can be introduced from the shell side of the module. In this case, the permeate is withdrawn from the bore side, and the non-permeate is taken from the shell side.

An example of a membrane-based air separation system is given in U.S. Pat. No. 4,881,953, the disclosure of which is incorporated by reference herein.

Other examples of fiber membrane modules are given in U.S. Pat. Nos. 7,497,894, 7,517,388, 7,578,871, and 7,662,333, the disclosures of which are all hereby incorporated by reference.

A polymer membrane becomes degraded in the presence of liquid water or water vapor. For this reason, it is common to provide some form of dehydration unit which treats the gas before it enters the gas separation module. Polymers have been developed which separate water vapor from a gas. An example of such a polymer is given in U.S. Pat. No. 7,294,174, the disclosure of which is incorporated by reference herein.

The compressed air supplied to a membrane module must also be free of particulates and oil vapor, such as the particles of oil, and the oil vapors, which leak from the compressor. Carbon beds are typically used to remove such particles of oil, and the oil vapor, from the air stream. But carbon beds can quickly become filled with hydrocarbons, and the beds are difficult to regenerate. Such regeneration typically requires extremely high temperatures, and the regeneration process may take considerable time, further reducing the efficiency of the process.

Furthermore, carbon beds of the prior art occupy valuable space. The carbon bed of the prior art is located in a separate housing, typically positioned adjacent to the fiber membrane module. This arrangement adds to the expense of a gas separation system.

The present invention provides an improved method and apparatus for separating gas mixtures, in which the feed gas entering a gas separation module is filtered through a fabric made of activated carbon fibers. The filter can either be formed integrally with the module, or it can be provided as a separate unit. The system so constructed has been found to operate with substantially greater efficiency than prior art systems, and also uses less space.

### SUMMARY OF THE INVENTION

The present invention comprises a gas separation module containing polymeric fibers. The module includes, or is accompanied by, a filter comprising a fabric made of activated carbon fibers, the fabric comprising a filter for the feed gas. In one embodiment, the filter is essentially part of the module.

In a first embodiment, in which the module is fed from the bore side, the filter is provided as a circular filter pad placed directly against the feed end tubesheet of the module. In another embodiment, in which the module uses shell-side feed, the filter is provided as a fabric wrapping which surrounds the body of the module. In yet another embodiment, also a shell-side fed module, the fabric is positioned near a core tube which receives the feed stream. In all of the above cases, the feed gas entering the module passes through the fabric before reaching the polymeric fiber membranes.

In an alternative embodiment, the filter is provided as a separate unit from the gas separation module, but the filter still comprises a fabric made of activated carbon fibers.

The invention also includes the method of directing a feed gas into a gas separation module which has an integrated activated carbon fabric filter. The feed gas is directed into the module, and passes through the carbon fabric before reaching the polymeric gas separation fibers of the module. Alternatively, the method includes passing the feed gas first through a module containing the filter material, and then through a conventional gas separation module.

Use of the gas separation module of the present invention has been found to be significantly advantageous compared to modules of the prior art. An integrated filter eliminates the need for a separately-housed carbon bed filter. The integrated module of the present invention provides better gas separation performance than does a conventional module operated with a separate filter. And if the filter is provided as a separate unit from the module, the filter still occupies substantially less volume than carbon bed filters of the prior art.

The present invention therefore has the primary object of providing an improved polymeric fiber membrane module for the non-cryogenic separation of a gas into components.

The invention has the further object of providing a gas separation module which includes an integrated filter for removing impurities from the input gas stream.

The invention has the further object of providing an integrated gas separation and filter module, which module can be used with both bore-side feed and shell-side feed arrangements.

The invention has the further object of providing an improved method and apparatus for the non-cryogenic separation of gases.

The invention has the further object of providing a gas separation system, in which a feed gas is filtered by passing it through a fabric made of activated carbon fibers.

The invention has the further object of reducing the space requirements for a gas separation membrane system, by providing a system which does not require a filter located in a separate housing, and/or by eliminating the need for a carbon bed.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1a provides a side elevational view of a fiber membrane module of a first embodiment of the present invention, shown partly exploded, in which a filter fabric is positioned at the inlet end of the module.

FIG. 1b provides a cross-sectional view of the module, taken along the line 1b-1b of FIG. 1a.

FIG. 2a provides a side elevational view of another embodiment of the present invention, in which a filter fabric is provided as a wrapping around the body of the fiber membrane module.

FIG. 2b provides a cross-sectional view of the module, taken along the line 2b-2b of FIG. 2a.

FIG. 3a provides a side elevational view, partly in cross-section, of another embodiment of the present invention, in which a filter fabric is provided in the vicinity of a core tube of the fiber membrane module.

FIG. 3b provides a cross-sectional view of the module, taken along the line 3b-3b of FIG. 3a.

FIG. 4 provides a partially broken-away, and partly exploded perspective view of another embodiment of the present invention, in which the module is spirally-wound.

FIG. 5 provides a block diagram of another embodiment of the invention, in which a filter comprising an activated carbon fabric is provided as a separate unit from the gas separation module.

### DETAILED DESCRIPTION OF THE INVENTION

The present invention comprises, in one embodiment, a polymeric fiber membrane module which has an integrated filter for pretreatment of a gas stream. The filter is made of an activated carbon fiber fabric, such as that sold under the trademark Zorflex (available from Chemviron Carbon Limited, High Tech House, Commerce Way, United Kingdom). The carbon fabric serves as an adsorption medium for in-situ pretreatment of feed gas directed into a gas separation membrane.

Air separation membrane modules typically need activated carbon adsorption beds to remove hydrocarbons, having weights of C₅ and higher, from the feed gas. If the hydrocarbons are not removed from the feed stream, the hydrocarbons would foul the membranes and thereby reduce their permeability and overall performance. It has been found that pretreatment filters made with Zorflex materials can protect the membranes from hydrocarbon-based contaminants, using only a fraction of the filter media volume required for conventional activated carbon beds. Filter pads, or their equivalent, made from these carbon fabrics, require only about 5% of the volume required for a traditional packed carbon bed, making the volume low enough that the filter can be included in the module itself, instead of being housed in a separate pressure vessel located outside of the membrane module.

Fiber membrane modules of the present invention can be provided for both bore-side and shell-side module designs, as well as spiral-wound module designs.

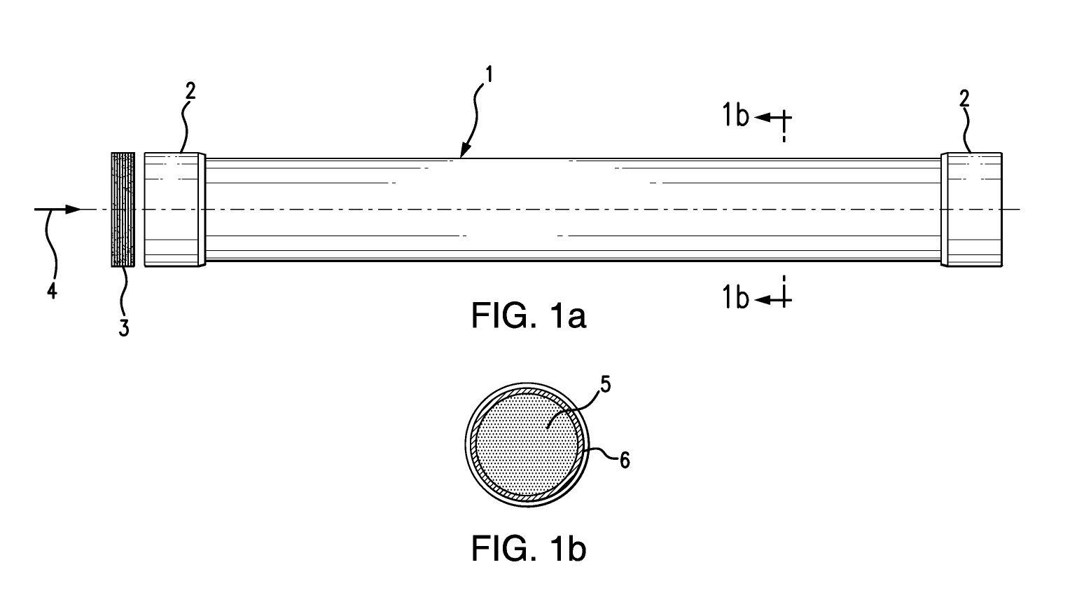

FIGS. 1a and 1b illustrate a first embodiment of the present invention, with side elevational and cross-sectional views, respectively. Fiber membrane module 1 includes tubesheets 2 at either end. A generally circular filter pad 3, comprising multiple plies of carbon cloth, is placed directly in front of the feed end tubesheet. The tubesheet face and its external casing hold the filter pad in place. The arrangement is shown in a partially exploded view in FIG. 1a. In actual practice, the filter pad 3 would be effectively attached to the module. All of the inlet gas 4 must pass through the filter pad before reaching the polymeric fibers inside the module.

The cross-sectional view of FIG. 1b shows module casing 6, enclosing fibers 5, which are represented by stippling in the drawing. The fibers extend longitudinally along the length of the module, and are therefore generally perpendicular to the paper in FIG. 1b.

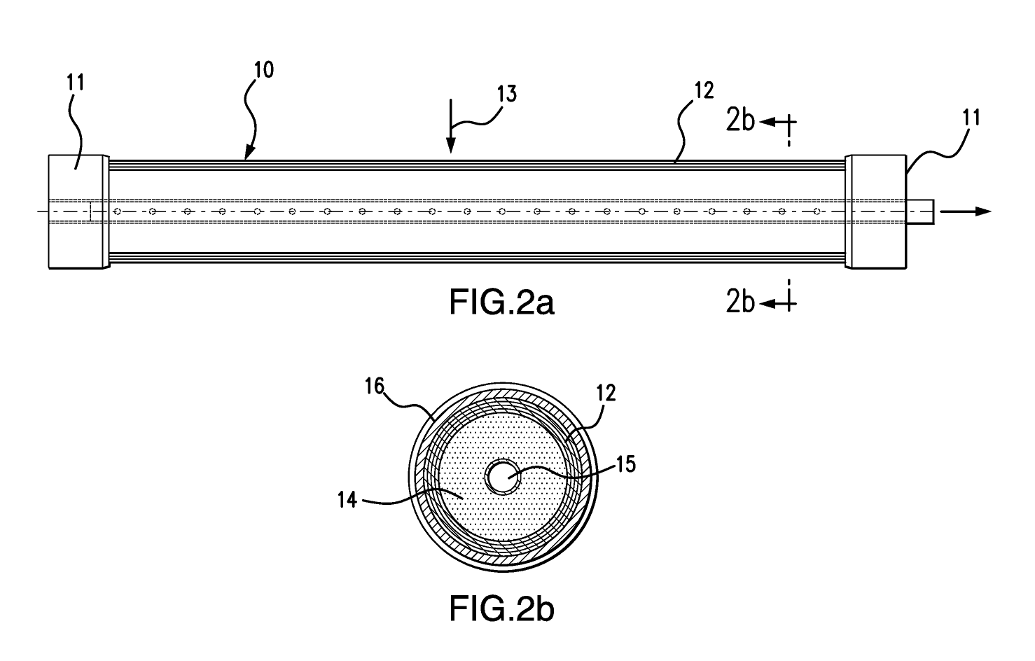

FIGS. 2a and 2b illustrate a second embodiment of the present invention. In this embodiment, fiber membrane module 10 has tubesheets 11. The module is fed from the shell side, meaning that the inlet gas stream first contacts the outside of the fibers, and not their inside. In the embodiment of FIGS. 2a and 2b, a generally cylindrical wrap 12 made of a multiple-ply carbon cloth is placed around the exterior of the module, as shown. The inlet gas 13 therefore flows through the carbon cloth before encountering the polymeric fibers inside the module. The pressure of the feed gas tends to hold the carbon cloth in place.

The cross-sectional view of FIG. 2b shows the fibers 14, arranged around core tube 15, and surrounded by wrap 12. As in the previous embodiment, the fibers extend along the length of the module, and are generally perpendicular to the paper in the view of FIG. 2b. FIG. 2b also shows module casing 16.

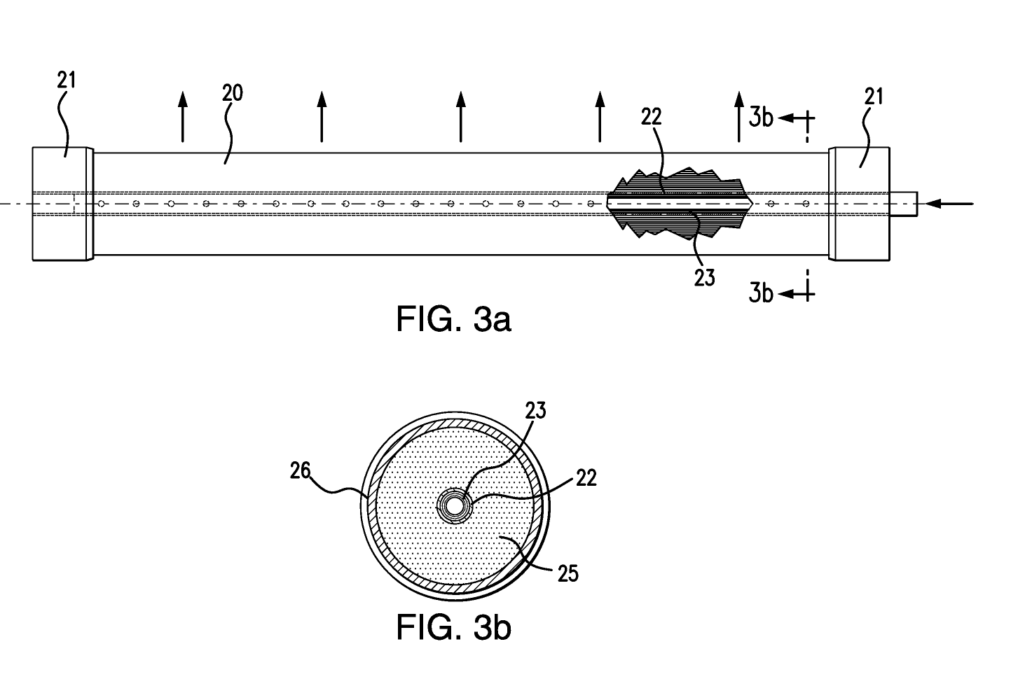

FIGS. 3a and 3b illustrate another embodiment, which is also shell-side fed. In this embodiment, the fiber membrane module 20, which has tubesheets 21, has a core tube 22. Note that, although the feed gas enters through a core tube, this module is still shell-side fed, because the gas still reaches the fibers at their outer surfaces, and not from their inner bores. In the embodiment of FIGS. 3a and 3b, a cylindrical tube formed of carbon cloth 23 is inserted inside the core tube. The tube of carbon cloth is again formed of multiple plies. The outer diameter of the filter cloth tube is smaller than the inner diameter of the core tube. The tube of carbon cloth is different from the core tube.

FIG. 3b shows fibers 25, arranged between the core tube and the module casing 26. As in the previous embodiments, the fibers extend along the length of the module, and are generally perpendicular to the paper in the view of FIG. 3b.

The carbon cloth, if formed with a sufficient number of plies, may be stiff enough to retain its shape inside the core tube. Alternatively, the carbon cloth could be supported by a porous structure, positioned inside the core tube. That is, there could be a separate scaffolding which supports the carbon cloth in its position inside the core tube.

In the embodiment of FIGS. 3a and 3b, the feed gas is injected into the core tube, and the feed gas flows through the filter material before it reaches any polymeric fibers inside the module.

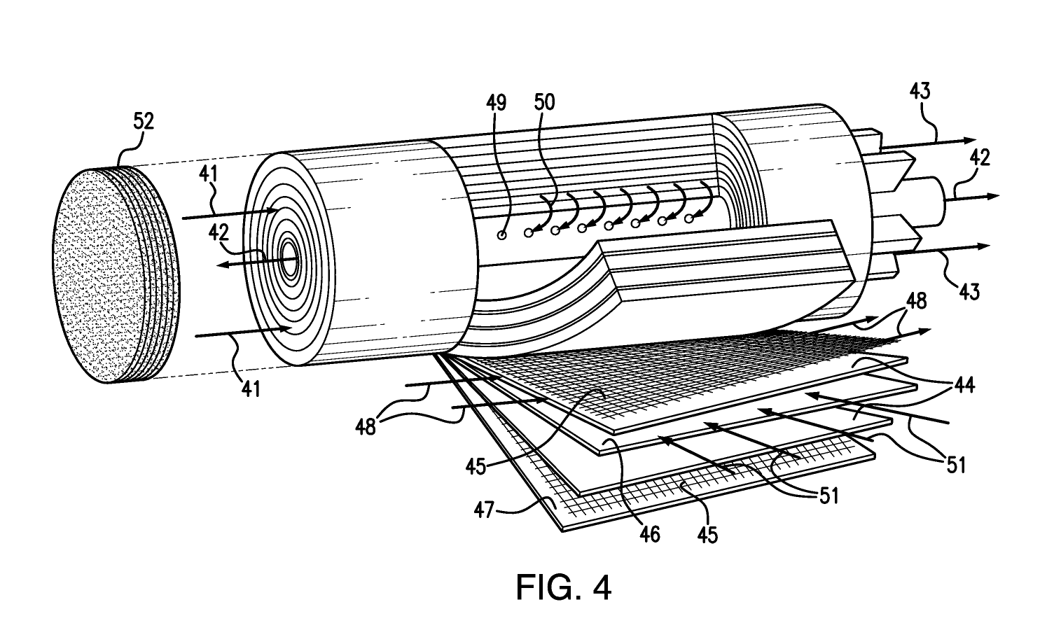

Another embodiment of the present invention is shown in the partly exploded perspective view of FIG. 4. In this embodiment, the module is spirally-wound. A spirally-wound module is typically fed from one end of the module.

In the example shown in FIG. 4, the inlet gas enters as shown by arrows 41. The permeate gas flows out as indicated by arrows 42. The retentate gas flow is indicated by arrows 43.

The layers of the spiral-wound module are partly broken away, for purposes of illustration in FIG. 4. In the broken away portion, one can see membrane material 44, feed channel spacers 45, and permeate collection material 46. Covering material 47 surrounds the layers. Arrows 48 indicate the direction of feed gas flow. Permeate gas enters a core tube through permeate collection holes 49, as indicated by arrows 50. Arrow 51 indicates the direction of permeate gas flow.

According to the present invention, a circular filter pad 52, which is similar to that shown in FIG. 1a, is affixed to the inlet end of the module. One may need to allow for the central core tube, used to remove the permeate gas, to pass through the filter pad.

The dimensions of the various filter pads, or filter cylinders or wraps, should be determined such that the residence time of the feed gas, in the filter, is about 0.05 seconds. Conventional carbon beds require a residence time of more than one second, while the activated carbon cloth can be effective at less than 0.05 seconds. Thus, for the same flow rate, one can see a twenty-fold reduction in volume requirements.

It is preferred that the carbon cloth filters, in all of the above embodiments, be replaceable. After the filter material has been saturated with hydrocarbons, it should be replaced. For some cases, where the risk of hydrocarbon contamination is low, or where the rate of contamination is accurately known to be very low, the carbon cloth filter may be integral to the remainder of the module.

A preferred material for the carbon filter material is Zorflex, as described above, but the invention is not necessarily limited to use with a particular brand of carbon fiber.

The present invention includes the membrane module having an integrated filter, and the method of use of such module. The method includes directing a feed gas into a membrane module which has an integrated filter, such that the feed gas must pass through the filter before reaching the polymeric fibers, and selecting the pressure of the feed gas such that the residence time of the feed gas, in the filter, is about 0.05 seconds. The feed gas, after passing through the filter material, then contacts the polymeric fiber membranes in the module, and the module then functions in the normal manner.

The following Example shows the performance of the present invention.

### EXAMPLE

A commercial air separation module was fitted with a custom pad of Zorflex FM50K, having a six-ply thickness, and having dimensions of 1.125×0.12 inches. The Zorflex material is sold in sheets of 0.5 mm thickness. The pad was attached to the feed end cap of the module.

The module was operated for three weeks, with a compressed air feed stream having a pressure of 120 psig. The feed stream contained about 0.1-0.5 ppm oil vapor, and the flow rate of the feed stream was 50 scfh, to produce a calculated residence time, in the filter, of 0.045 seconds.

A second module, without the filter pad, but otherwise the same as the first module, was run with the same feed air stream.

A third module, similar to the others, was operated with a standard carbon bed, positioned upstream of the module, in which the residence time of the feed stream, in the filter, was one second.

Both before and after the above-described three-week treatment, the modules were tested at standard conditions (145 psig feed air, 25° C. and 4.5 slpm product flow). The test included measurements of both product oxygen content and permeate flow. The three-week operation itself was performed at non-standard conditions (i.e. 120 psig pressure). Thus, the module was physically removed from the durability test system, and was re-installed in a separate test unit, to conduct the test under standard conditions, wherein the module was evaluated for possible changes in performance.

In this test, all of the modules were of the boreside feed type, in which the product (nitrogen) was the retentate gas. The test included measurement of the amount of oxygen in the product stream. The lower the amount, the better the performance of the module.

For the module with no filter pad, the concentration of oxygen in the product was 0.48% before the test, and 0.63% at the end of the test. This result indicated that the performance of the module had degraded during the three-week treatment, because the percentage of oxygen in the product stream had increased. Also, the permeate flow before the test was 14.6 slpm, whereas the permeate flow at the end of the test was 11.8 slpm (standard liters per minute). Thus, the module also was degraded with respect to the amount of permeate flow.

For the module with the filter pad of the present invention, the concentration of oxygen in the product stream was 0.41% before the test, and 0.41% at the end of the test. The permeate flow rate at the beginning was 12.7 slpm, and the permeate flow rate at the end was 12.7 slpm. Thus, for the module made according to the present invention, there was no degradation of performance, with respect to residual oxygen, and there was no degradation with respect to permeate flow.

For the module which was used with a conventional carbon bed filter positioned upstream of the module, the result was that the oxygen concentration, in the product stream, at the beginning of the test was 0.48%, and the concentration of oxygen at the end of the test was 0.50%. The permeate flow rate at the beginning was 14.2 slpm, and the permeate flow rate at the end was 14.2 slpm.

Thus, the module which had the carbon pad, according to the present invention, performed better than the module protected with a traditional carbon bed, and much better than a module containing no carbon protection at all. The degradation in performance of the module which was operated without any carbon filter was consistent with known degradation due to exposure to oil.

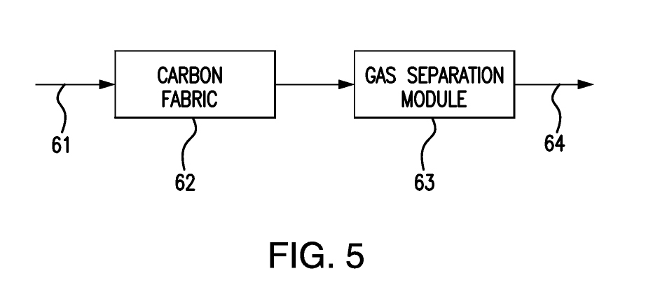

Another embodiment of the present invention is shown in the block diagram of FIG. 5. In this embodiment, the filter is provided as a module 62 which is separate from the gas separation module 63. The filter in module 62 comprises one or more layers of activated carbon fabric. The feed gas enters through conduit 61, and the product gas exits through conduit 64.

In effect, the embodiment of FIG. 5 comprises the replacement of a conventional carbon bed with a module containing a carbon fabric. Such carbon fabrics form a filter that is much more compact than conventional carbon bed filters, and contain only about 1/20 of the amount of carbon, by weight, as a traditional stand-alone carbon particulate bed filter.

A preferred filter module for use in the embodiment of FIG. 5 is available, in fully assembled form, from Nano-Purification Solutions Inc., of Huntersville, N.C. That is, the module 62 comprises a complete unit, comprising a housing containing the carbon fabric. An example of a filter module which can be used in the present invention is the item sold under the product number NF0070AC.

Another preferred filter module for use in the embodiment of FIG. 5 is that sold under the product number N50A1882AC, also sold by Nano-Purification Solutions Inc. This filter will process 1882 scfm of air at 725 psig with a volume of 0.38 ft³. It is 5.8 inches in diameter and 25 inches long. A carbon bed sized for the same flow would be 13 inches in diameter and 16 inches in height, for a volume of 1.23 ft³. Thus, the traditional carbon bed would require 3.2 times the volume needed for the filter module containing carbon fabric. This factor would be closer to twenty times if the carbon cloth filter used a similar packing density to that of the packed bed of traditional activated carbon particles.

In other words, a carbon filter using the activated carbon fabric described above can be 3-4 times smaller in volume than a packed bed using traditional activated carbon particles.

Therefore, even when a filter module is provided as a separate unit from the gas separation module, the overall system can occupy substantially less space than comparable systems of the prior art.

The invention can be modified in ways that will be apparent to those skilled in the art. The filter material may be varied, and is not limited to those mentioned above. The carbon fabric used in the first embodiment, wherein the filter is integral with the gas separation module, could be used in making the stand-alone filter module represented in the embodiment of FIG. 5, and vice versa.

The gas separation module can be of bore-side or shell-side feed. The dimensions, and number of plies, of the filter material can also be varied to suit different applications.

These modifications should be considered within the spirit and scope of the following claims.

What is claimed is:

1. In a gas separation membrane module, the module comprising a plurality of hollow polymeric fibers, the fibers being held within a cylindrical casing having two ends, the fibers being anchored by tubesheets positioned at the two ends of the casing,
the improvement comprising:
a filter which is integral with the module, the filter being positioned such that all gas entering the module must pass through the filter before reaching the fibers.

2. The improvement of claim 1, wherein the filter is made of an activated carbon fiber fabric.

3. The improvement of claim 1, wherein the filter comprises a generally circular pad having multiple plies, the circular pad being affixed to one of the tubesheets.

4. The improvement of claim 1, wherein the filter comprises a generally cylindrical wrap positioned around the fibers of the module.

5. The improvement of claim 1, wherein the module includes a core tube, and wherein the filter comprises a cylindrical tube of filter material, positioned inside the core tube.

6. In a gas separation module, the module comprising a plurality of spirally-wound layers containing polymeric material selected for gas separation, the module having an inlet for a feed gas, the improvement comprising a filter pad, affixed to the inlet, the filter pad comprising a plurality of layers of fabric made of activated carbon fibers, wherein substantially all of the feed gas passes through the filter pad before contacting the layers of polymeric material.

7. A method of non-cryogenic separation of a gas into components, comprising the steps of:
a) providing a membrane module which includes polymeric fibers, the module also having an integrated filter, and
b) directing a feed gas into the module, the directing step being performed such that all gas entering the module must first pass through the filter before reaching the fibers.

8. The method of claim 7, further comprising the step of controlling a pressure of the feed gas so as to control a residence time of gas in the filter.

9. The method of claim 8, wherein the pressure is controlled so that the residence time of the feed gas in the filter is about 0.05 seconds.

10. A gas separation membrane module, comprising:
a) a plurality of elongated hollow polymeric fibers, held within a casing, the fibers being anchored by tubesheets disposed at two ends of the module,
b) a filter material which is affixed to the module, the filter material being positioned such that all gas entering the module must pass through the filter material before reaching the fibers.

11. The module of claim 10, wherein the filter material comprising an activated carbon fiber fabric.

12. The module of claim 11, wherein the filter material comprises a generally circular pad including a plurality of plies of filter material, the pad being affixed to one of said tubesheets of the module.

13. The module of claim 11, wherein the filter material comprises a generally cylindrical wrap positioned around the fibers of the module, the wrap being located inside the casing, the wrap defining multiple layers of filter material.

14. The module of claim 11, wherein the module includes a core tube, and wherein the filter comprises a cylindrical tube of filter material, positioned inside the core tube.

15. A gas separation system comprising a filter module and a gas separation module, the filter module comprising an activated carbon fabric, the gas separation module comprising a plurality of hollow polymeric fibers, the system also including inlet and outlet ports, wherein all gas entering the inlet port must pass through the filter module before reaching the gas separation module.

16. A method of non-cryogenic separation of a gas into components, comprising the steps of:
a) directing a feed gas into a filter module, the filter module containing an activated carbon fabric, wherein all of said feed gas passes through at least a part of said fabric,
b) directing gas which has passed through the filter module into a gas separation module which includes polymeric fibers, so as to separate the gas into components.
